(19) United States
(12) Patent Application Publication
(10) Pub. No.: US 2010/0005603 A1
(43) Pub. Date: Jan. 14, 2010

(54) APPARATUS FOR DELIVERING OR WITHDRAWING A FLEXIBLE TUBULAR CASING OF A PIPE CLEANING DEVICE

(76) Inventor: Chin-Yuan Liu, Taichung City (TW)

Correspondence Address: HOLLAND & HART, LLP, P.O BOX 8749, DENVER, CO, 80201, US

(21) Appl. No.: 12/498,997

(22) Filed: Jul. 7, 2009

(30) Foreign Application Priority Data
Jul. 9, 2008 (TW) 097212153

(51) Int. Cl. B08B 9/00

(52) U.S. Cl. 15/28

(57) ABSTRACT

An apparatus includes a driving shaft which is disposed in a housing unit, which is rotatable with a drive unit, and which is adapted to be coupled with a flexible twisting member disposed in a flexible tubular casing of a pipe cleaning device to rotate a scrubbing head for scrubbing an inner wall of a pipe, and a plurality of rollers cooperatively defining a traveling path. One of the rollers is rotatable with the driving shaft. The flexible tubular casing is drawn by the rotation of the rollers to move along the traveling path so as to be delivered or withdrawn. A control module is disposed to control the operation of the drive unit. A switch unit is actuated to send a switch-off signal to the control module when the flexible tubular casing is tensed so as to stop the drive unit.

### CROSS-REFERENCE TO RELATED APPLICATION

This application claims priority of Taiwanese Utility Model Application No. 097212153, filed on Jul. 9, 2008, the disclosure of which is herein incorporated by reference.

### BACKGROUND OF THE INVENTION

1. Field of the Invention

This invention relates to a pipe cleaning device, more particularly to an apparatus for delivering or withdrawing a flexible tubular casing of a pipe cleaning device.

2. Description of the Related Art

A conventional apparatus for cleaning caking adhered to the inner wall of a pipe as disclosed in U.S. Pat. No. 6,263,535 B1 includes a scrubber which is retractably movable into a waste gas pipe by a flexible rod. The flexible rod is retractably and automatically received in a chamber by a winding machine therein. Other tube cleaning apparatuses are disclosed in U.S. Pat. Nos. 5,426,807 and 5,235,718, in which a flexible casing and brush assembly is motor-driven to move into and out of tubes. However, since the aforementioned cleaning apparatuses do not have any mechanism to detect the state of the flexible rod or casing when it is fed to the full length thereof and to automatically stop a motor, overheating of the motor and damage to relative component parts may occur.

### SUMMARY OF THE INVENTION

The object of the present invention is to provide an apparatus for delivering or withdrawing a flexible tubular casing of a pipe cleaning device, which can prevent damage to a drive motor and relative component parts of the pipe cleaning device during operation.

According to this invention, the apparatus includes a housing unit, a drive unit disposed in the housing unit, and a driving shaft which is disposed in the housing unit and which is driven by the drive unit to revolve about a first revolving axis. The driving shaft includes a first shaft segment adapted to be coupled with a flexible twisting member of a pipe cleaning device to permit rotation of a rotatable scrubbing head, and a second shaft segment. A retaining member is configured to hold a flexible tubular casing of the pipe cleaning device onto the housing unit with a resisting force. A roller assembly includes a primary roller mounted to rotate with the second shaft segment about the first revolving axis, and at least one secondary roller disposed to be revolvable about a second revolving axis that is parallel to the first revolving axis. The primary and secondary rollers are configured to cooperate with one another to define a traveling path. The flexible tubular casing is adapted to be brought into the housing unit to be engaged with the primary and secondary rollers, and is drawn by the rotation of the rollers to move along the traveling path so as to be delivered out of the housing unit. A gear train includes an input gear mounted to revolve with the second shaft segment about the first revolving axis, and at least one driven gear meshing with the input gear and driving the secondary roller to revolve about the second revolving axis. A control module is electrically connected to the drive unit and is operable to control operation of the drive unit. A switch unit is disposed to be actuated once a juncture of the flexible tubular casing reaches the traveling path to thereby result in tensing of the flexible tubular casing by the resisting force. The switch unit sends a switch-off signal to the control module upon being actuated so as to stop the drive unit.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of the preferred embodiment of an apparatus for delivering or withdrawing a flexible tubular casing of a pipe cleaning device according to this invention;

FIG. 2 is a fragmentary sectional view illustrating a control handle of the apparatus of the preferred embodiment;

FIG. 3 is an exploded perspective view of a control pedal of the apparatus of the preferred embodiment;

FIG. 4 is a partly sectional view of the preferred embodiment; and

FIG. 5 is a schematic bottom view of the preferred embodiment.

### DETAILED DESCRIPTION OF THE PREFERRED EMBODIMENT

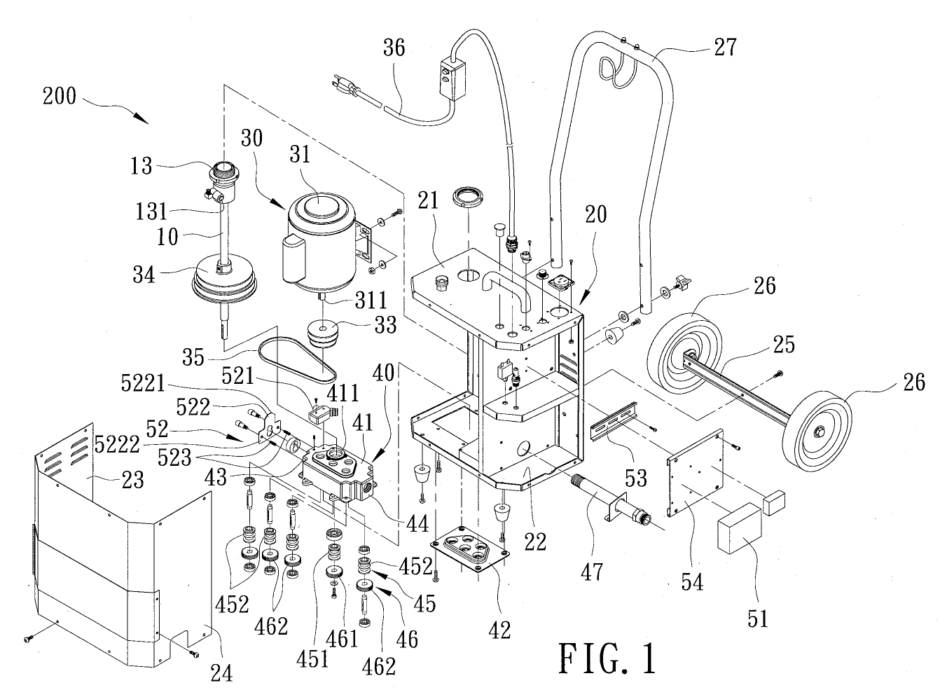

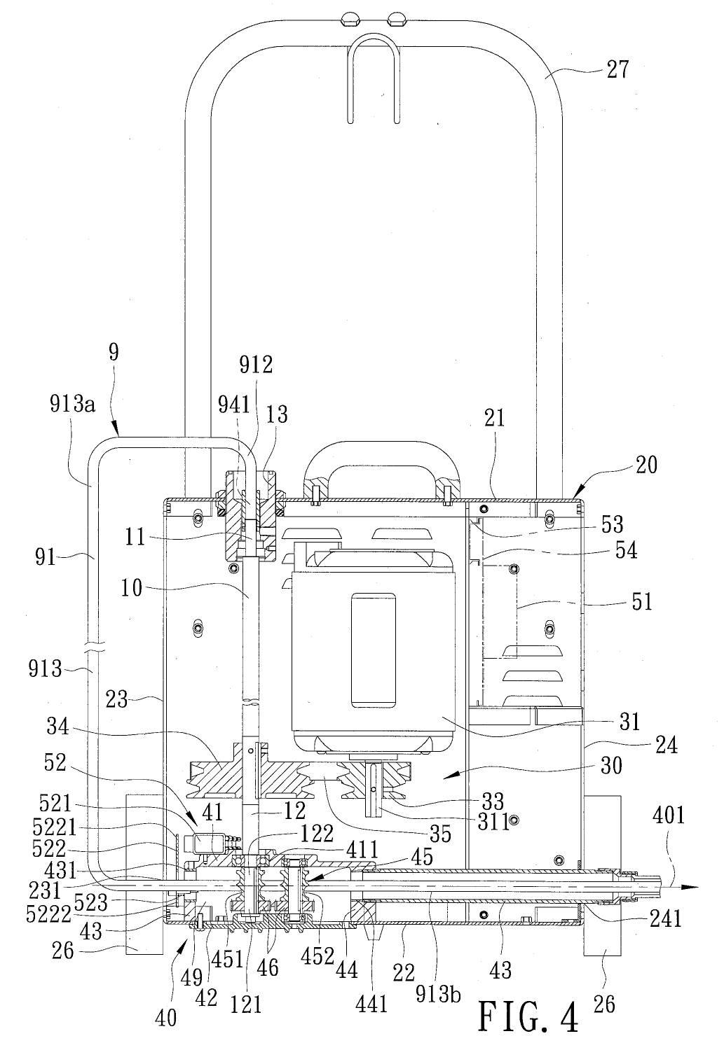

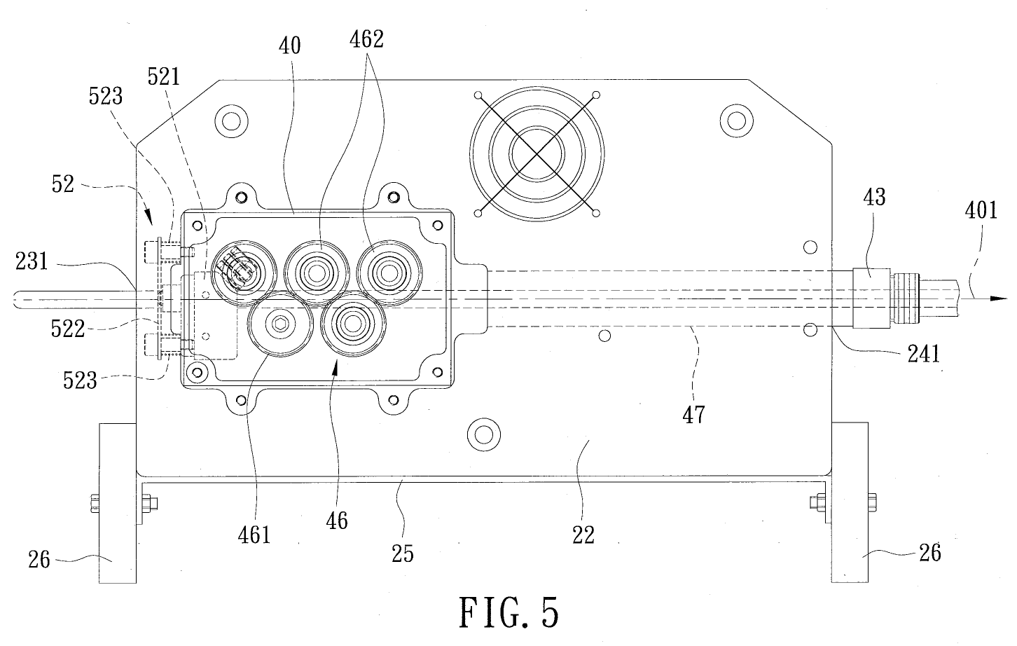

Referring to FIGS. 1 to 5, the preferred embodiment of an apparatus 200 according to the present invention is adapted for delivering or withdrawing a pipe cleaning device 9. The pipe cleaning device 9 includes a rotatable scrubbing head 92, a flexible twisting member 94 which has a drive pick-up end 941 and a drive delivering end 942 that is coupled to the rotatable scrubbing head 92 for rotating the rotatable scrubbing head 92, and a flexible tubular casing 91 which encases the flexible twisting member 94 and which has a cleaning-side end 911 disposed to carry the rotatable scrubbing head 92, a pull resisting end 912, and a tubular casing segment 913 interposed between the cleaning-side and pull resisting ends 911, 912. The tubular casing segment 913 includes non-roller engageable and roller engageable regions (913a, 913b) which are respectively proximate to and distal from the pull resisting end 912, and which define a juncture therebetween.

The apparatus 200 of this embodiment comprises a housing unit 20, a frame unit 40, a drive unit 30, a driving shaft 10, a roller assembly 45, a gear train 46, a control module 51, a switch unit 52, a control handle 60, and a control pedal unit 70.

The housing unit 20 has first and second walls 21, 22 which are spaced apart from each other in a longitudinal direction, and third and fourth walls 23, 24 which are spaced apart from each other in a transverse direction relative to the longitudinal direction, and which respectively have inlet and outlet ports 231, 241 aligned with each other in the transverse direction. A pair of wheels 26 are rotatably mounted laterally of the third and fourth walls 23, 24 through a wheel axle 25. A handle 27 is mounted on and extends from the first wall 21 to facilitate carrying of the housing unit 20.

The frame unit 40 includes a platform 41 which is spaced apart from the second wall 22 to define a passageway 49 therebetween, and which has a bearing hole 411 that extends along a first revolving axis in the longitudinal direction and that is communicated with the passageway 49, a bottom plate 42 secured to the second wall 22, and left and right posts 43,44 which are spaced apart from each other in the transverse direction, and which respectively have left and right openings 431, 441.

The drive unit 30 is disposed in the housing unit 20. The driving shaft 10 is disposed between the first and second walls 21, 22, and is driven by the drive unit 30 to revolve about the first revolving axis.

Specifically, the drive unit 30 includes a drive reversible motor 31 having an output shaft 311, two pulleys 33, 34 rotatably and respectively mounted on the output shaft 311 and the driving shaft 10, a belt 35 trained on the pulleys 33, 34 so as to transmit drive of the output shaft 311 to the driving shaft 10, and an electric power line 36 extending through the first wall 21.

The driving shaft 10 includes first and second shaft segments 11,12 that are proximate to the first and second walls 21, 22, respectively. The first shaft segment 11 is adapted to be coupled with the drive pick-up end 941 of the flexible twisting member 94 of the pipe cleaning device 9 so as to permit the drive delivering end 942 to rotate the rotatable scrubbing head 92 in a known manner. The second shaft segment 12 is rotatably mounted in the bearing hole 411, and includes force-transmitting and drawing regions 121, 122 which are disposed between the platform 41 and the bottom plate 42.

Moreover, a retaining member 13 is configured to hold the pull resisting end 912 of the flexible tubular casing 91 onto the first wall 21 with a resisting force while permitting the drive pick-up end 941 of the flexible twisting member 94 to revolve with the first shaft segment 11. Preferably, the retaining member 13 has a water inlet 131 adapted to be connected to a water pipe (not shown) for introducing water into the flexible tubular casing 91 so as to facilitate cleaning of a pipe using the rotatable scrubbing head 92.

The roller assembly 45 includes a primary roller 451 which is mounted to rotate with the drawing region 122 of the driving shaft 10 about the first revolving axis, and a plurality of secondary rollers 452 which are respectively disposed to be revolvable about second revolving axes that are parallel to the first revolving axis. The rollers 451, 452 are configured to cooperate with one another to define a traveling path 401 extending in the transverse direction. Thus, when the roller engageable region (913b) of the flexible tubular casing 91 is driven through the inlet port 231 to be engaged with the rollers 451, 452, the roller engageable region (913b) is drawn by the rotation of the rollers 451, 452 to move along the traveling path 401 so as to be delivered out of the outlet port 241.

The gear train 46 includes an input gear 461 that is mounted to revolve with the force-transmitting region 121 of the driving shaft 10 about the first revolving axis, and a plurality of driven gears 462. One of the driven gears 462 meshes with the input gear 461 to be driven to revolve about the corresponding second revolving axis. The remaining driven gears 462 are driven to revolve about their respective second revolving axes.

Preferably, a tubular sleeve 47 extends between the right post 44 and the fourth wall 24, and communicates the right opening 441 with the outlet port 241 so as to guide the roller engageable region (913b) out of the outlet port 241.

A control plate 54 is slidably disposed on the housing unit 20 through a slide rail 53. The control module 51 is disposed on the control plate 54 and is electrically connected to the drive unit 30 so as to control the operation of the motor 31.

The switch unit 52 is disposed between the inlet port 231 and the roller assembly 45. Specifically, the switch unit 52 includes a limit switch 521, a sensor plate 522, and two biasing members 523. The limit switch 521 is disposed on the platform 41 and is operable to emit a switch-off signal. The sensor plate 522 has a pressing portion 5221 which confronts and is spaced apart from the limit switch 521 in the transverse direction, and an actuated portion 5222 which has an inner peripheral wall for extension of the roller engageable region (913b) of the flexible tubular casing 91 therethrough when the flexible tubular casing 91 is delivered or withdrawn. The left post 43 is disposed between the sensor plate 522 and the roller assembly 45. The biasing members 523 are secured to the left post 43 so as to bias the actuated portion 5222 of the sensor plate 522 away from the roller assembly 45.

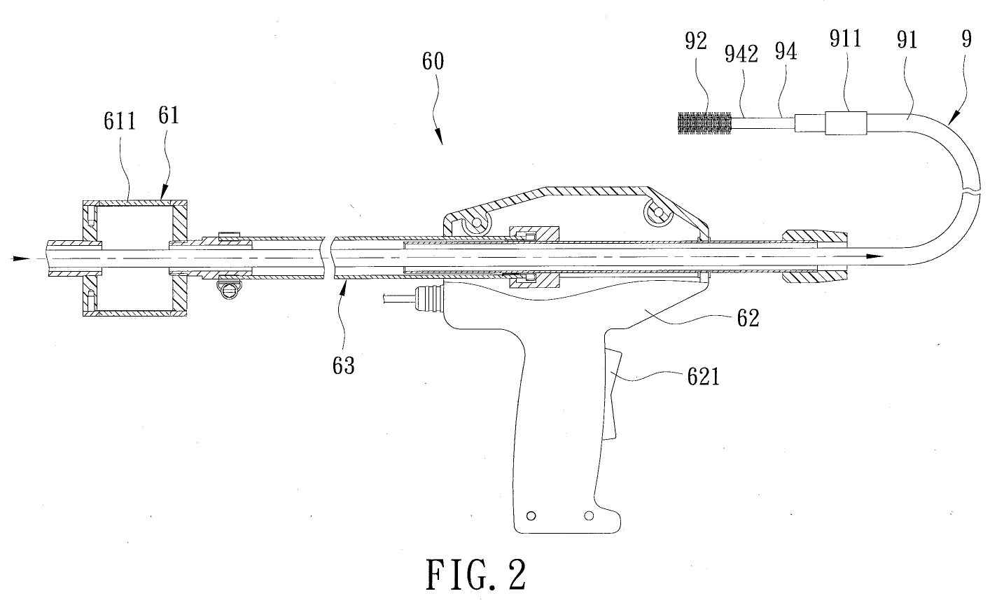

With reference to FIG. 2, the control handle 60 is adapted to be disposed proximate to the cleaning-side end 911 of the flexible tubular casing 91, and has a handgrip 62 for gripping by a user and having a control button 621 operable to control the operation of the motor 31, a viewing portion 61 which has a viewing window 611 to permit the user to observe the flexible tubular casing 91, and a hose 63 interconnecting the viewing portion 61 and the handgrip 62.

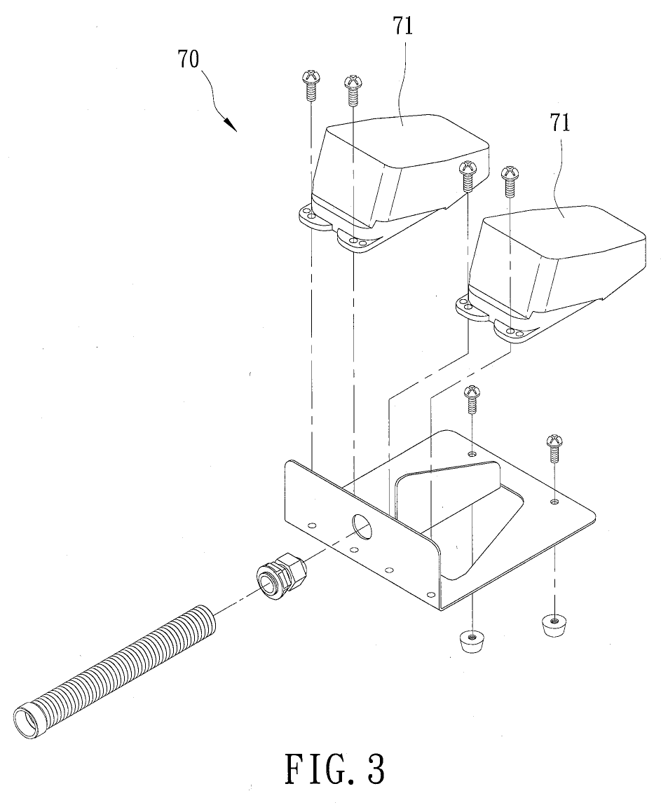

With reference to FIG. 3, the control pedal unit 70 includes two operating pedals 71 which are electrically connected to the control module 51 and which are operable to control the operation of the motor 31.

During the delivering of the flexible tubular casing 91 of the pipe cleaning device 9 out of the outlet port 241, once the juncture of the flexible tubular casing 91 reaches the traveling path 401 such that the non-roller engageable region (913a) is tensed by the resisting force, the non-roller engageable region (913a) is deformed and drags the inner peripheral wall of the sensor plate 522 towards the roller assembly 45 against the biasing forces of the biasing members 523, thereby bringing the pressing portion 5221 into contact with the limit switch 521 and actuating the limit switch 521, which sends a switch-off signal to the control module 51 to stop the motor 31. Hence, the motor 31 can stop operation automatically to prevent damage to the motor 31 and the relative component parts. While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. An apparatus for delivering or withdrawing a flexible tubular casing of a pipe cleaning device, the pipe cleaning device including a rotatable scrubbing head and a flexible twisting member which has a drive pick-up end and a drive delivering end that is coupled to the rotatable scrubbing head for rotating the rotatable scrubbing head, the flexible tubular casing encasing the flexible twisting member, and having a cleaning-side end which is disposed to carry the rotatable scrubbing head, a pull resisting end, and a tubular casing segment which is interposed between the cleaning-side and pull resisting ends and which includes non-roller engageable and roller engageable regions that are respectively proximate to and distal from the pull resisting end, and that define a juncture therebetween, said apparatus comprising:
a housing unit having first and second walls which are spaced apart from each other in a longitudinal direction, and third and fourth walls which are spaced apart from each other in a transverse direction relative to the longitudinal direction, and which respectively have inlet and outlet ports aligned with each other in the transverse direction;
a drive unit disposed in said housing unit;
a driving shaft which is disposed between said first and second walls and which is driven by said drive unit to revolve about a first revolving axis in the longitudinal direction, and which includes first and second shaft segments that are proximate to said first and second walls, respectively, said first shaft segment being adapted to be coupled with the drive pick-up end of the flexible twisting member so as to permit the drive delivering end to rotate the rotatable scrubbing head, said second shaft segment including force-transmitting and drawing regions that are respectively proximate to and distal from said second wall;
a retaining member configured to hold the pull resisting end of the flexible tubular casing onto said first wall with a resisting force while permitting the drive pick-up end of the flexible twisting member to revolve with said first shaft segment;
a roller assembly including a primary roller which is mounted to rotate with said drawing region about the first revolving axis, and at least one secondary roller which is disposed to be revolvable about a second revolving axis that is parallel to said first revolving axis, said primary and secondary rollers being configured to cooperate with one another to define a traveling path which extends in the transverse direction such that, when the roller engageable region of the flexible tubular casing is adapted to be driven through said inlet port to be engaged with said primary and secondary rollers, the roller engageable region is drawn by the rotation of said primary and secondary rollers to move along the traveling path so as to be delivered out of said outlet port;
a gear train which includes an input gear that is mounted to revolve with said force-transmitting region about the first revolving axis, and at least one driven gear that meshes with said input gear and that drives said secondary roller to revolve about the second revolving axis;
a control module electrically connected to said drive unit so as to control operation of said drive unit; and
a switch unit which is disposed between said inlet port and said roller assembly, and which is configured to be actuated once the juncture of the flexible tubular casing reaches the traveling path to thereby result in tensing of the non-roller engageable region by the resisting force, said switch unit sending a switch-off signal to said control module upon being actuated so as to stop said drive unit.

2. The apparatus according to claim 1, wherein said switch unit includes
a limit switch disposed to be actuated to emit the switch-off signal,
a sensor plate which has a pressing portion that is spaced apart from said limit switch in the transverse direction, and an actuated portion that has an inner peripheral wall, said inner peripheral wall being configured to permit the roller engageable region to pass therethrough when the flexible tubular casing is delivered or withdrawn, and to be dragged toward said roller assembly when the non-roller engageable region is tensed by the resisting force and is thereby deformed, thereby bringing said pressing portion into contact with said limit switch to actuate said limit switch; and
a biasing member which is disposed to bias said actuated portion away from said roller assembly.

3. The apparatus according to claim 2, further comprising
a frame unit including
a platform which is spaced apart from said second wall to define a passageway therebetween, and which has a bearing hole that extends along the first revolving axis and that is communicated with said passageway such that said second shaft segment of said driving shaft is rotatably mounted in said bearing hole and said force-transmitting and drawing regions are disposed between said platform and said second wall, and
left and right posts which are spaced apart from each other in the transverse direction, and which respectively have left and right openings configured to permit the roller engageable region of the flexible tubular casing to be led in and out of said passageway.

4. The apparatus according to claim 3, wherein said left post is disposed between said sensor plate and said roller assembly, said biasing member being secured to said left post to bias said actuated portion of said sensor plate away from said roller assembly.

5. The apparatus according to claim 4, wherein said limit switch is disposed on said platform and confronts said pressing portion of said sensor plate.

6. The apparatus according to claim 5, further comprising a tubular sleeve which extends between said right post and said fourth wall, and which communicates said right opening with said outlet port so as to guide the roller engageable region out of said outlet port.

7. The apparatus according to claim 1, wherein said drive unit includes a drive motor having an output shaft, two pulleys rotatably and respectively mounted on said output shaft and said driving shaft, and a belt trained on said pulleys so as to transmit drive of said output shaft to said driving shaft.

8. The apparatus according to claim 1, further comprising a control handle which is adapted to be disposed proximate to the cleaning-side end of the flexible tubular casing, and which has a handgrip provided with a control button that is operable to control operation of said drive unit for delivering or withdrawing the flexible tubular casing.

9. The apparatus according to claim 1, further comprising a control pedal unit which is electrically connected to said control module and which is operable to control operation of said drive unit to deliver or withdraw the flexible tubular casing.

10. The apparatus according to claim 1, further comprising a pair of wheels rotatably mounted laterally of said third and fourth walls and opposite to each other in the transverse direction, and a handle mounted on and extending from said first wall to facilitate carrying of said housing unit.
